(19) United States
(12) Patent Application Publication
(10) Pub. No.: US 2018/0073702 A1
(43) Pub. Date: Mar. 15, 2018

(54) Architectural Window with Built-In QLED Lighting

(71) Applicant: NANOSYS, Inc., Milpitas, CA (US)

(72) Inventors: Jason Hartlove, Milpitas, CA (US); Andrew L. Filler, Milpitas, CA (US)

(21) Appl. No.: 15/700,369

(22) Filed: Sep. 11, 2017

Related U.S. Application Data
(60) Provisional application No. 62/395,173, filed on Sep. 15, 2016.

(51) Int. Cl. F21V 9/16; E06B 7/00; F21V 33/00

(52) U.S. Cl. CPC F21V 9/16; F21V 33/006; E06B 7/00

(57) ABSTRACT

Embodiments of the present application relate to the arrangement of quantum dot optics on architectural windows. An illumination device includes a first conductive layer, a second conductive layer, and a polymer layer disposed between the first conductive layer and the second conductive layer. The polymer layer includes a plurality of quantum dots. The first conductive layer, the polymer layer, and the second conductive layer form a layer stack disposed on a surface of a window pane.

### CROSS REFERENCE TO RELATED APPLICATIONS

This application claims benefit to and incorporates by reference in its entirety U.S. Provisional Application No. 62/395,173, filed Sep. 15, 2016.

### Field

The present application relates to quantum dot emission technology, and to architectural windows that utilize quantum dot optics.

### Background

Semiconductor nanocrystallites (quantum dots) whose radii are smaller than the bulk exciton Bohr radius constitute a class of materials intermediate between molecular and bulk forms of matter. Quantum confinement of both the electron and hole in all three dimensions leads to an increase in the effective band gap of the material with decreasing crystallite size. Consequently, both the optical absorption and emission of quantum dots shift to the blue (higher energies) as the size of the dots gets smaller. Incorporating quantum dots in display devices, such as LCDs, has been shown to produce highly vibrant colors while reducing the overall power consumption. Quantum dots provide desirable characteristics due to their low power consumption, low manufacturing cost, and highly vibrant light output.

### SUMMARY

Embodiments of the present application relate to the arrangement of quantum dot optics on architectural windows.

According to an embodiment, an illumination device includes a first conductive layer, a second conductive layer, and a polymer layer disposed between the first conductive layer and the second conductive layer. The polymer layer includes a plurality of quantum dots. The first conductive layer, the polymer layer, and the second conductive layer form a layer stack disposed on a surface of a window pane.

According to another embodiment, a luminescent window includes a first glass pane and a second glass pane oriented substantially parallel with the first glass pane and separated from the first glass pane by a given distance. The luminescent window also includes a QLED device that has a first conductive layer, a second conductive layer, and a polymer layer disposed between the first conductive layer and the second conductive layer. The polymer layer includes a plurality of quantum dots. The QLED device is disposed on a surface of the first glass pane or a surface of the second glass pane, such that the QLED device is between the first glass pane and the second glass pane.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present embodiments and, together with the description, further serve to explain the principles of the present embodiments and to enable a person skilled in the relevant art(s) to make and use the present embodiments.

FIG. 1 illustrates the structure of a quantum dot (QD), according to an embodiment.

FIG. 2 illustrates a luminescent window using a QLED structure, according to an embodiment.

FIG. 3 illustrates a more detailed view of the QLED structure, according to an embodiment.

FIG. 4 illustrates the incorporation of photovoltaic cells with the QLED, according to an embodiment.

FIG. 5 illustrates an arrangement of QLEDs on a window pane, according to an embodiment.

The features and advantages of the present embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

Although specific configurations and arrangements may be discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications beyond those specifically mentioned herein.

It is noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

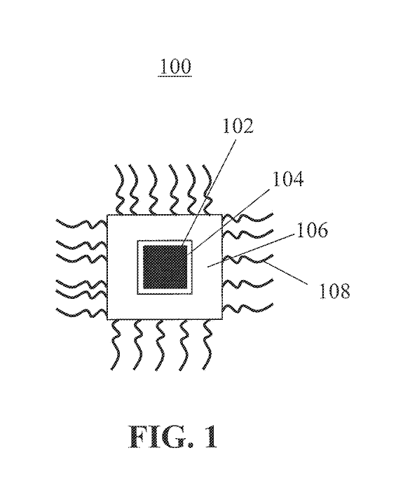

Before describing the details of the embodiments herein, a brief description of quantum dots will be discussed. Quantum dots may be used in a variety of applications that benefit from having sharp, stable, and controllable emissions in the visible and infrared spectrum. FIG. 1 illustrates an example of the core-shell structure of a quantum dot 100, according to an embodiment. Quantum dot 100 includes a core material 102, an optional buffer layer 104, a shell material 106, and a plurality of ligands 108.

Core material 102 includes a semiconducting material that emits light upon absorption of higher energies. Examples of core material 102 include indium phosphide (InP), cadmium selenide (CdSe), zinc sulfide (ZnS), lead sulfide (PbS), indium arsenide (InAs), indium gallium phosphide, (InGaP), and cadmium telluride (CdTe). Any other III-V, tertiary, or quaternary semiconductor structures that exhibit a direct band gap may be used as well. Of these materials, InP and CdSe are most often used, but InP is more desirable to implement over CdSe due to the toxicity of CdSe dust. CdSe may exhibit emissions having a full-width-half-max (FWHM) range of around 30 nm while InP may exhibit emissions having a FWHM range of around 40 nm.

Buffer layer 104 may surround core material 102. Buffer layer 104 may be zinc selenide sulfide (ZnSeS) and is typically very thin (e.g., on the order of 1 monolayer). Buffer layer 104 may be utilized to help increase the bandgap of core material 102 and improve the quantum efficiency.

Shell material 106 may be on the order of two monolayers thick and is typically, though not required, also a semiconducting material. The shells provide protection to core material 102. A commonly used shell material is zinc sulfide (ZnS), although other materials may be used as well. Shell material 106 may be formed via a colloidal process similar to that used to form core material 102.

Ligands 108 may be adsorbed or bound to an outer surface of shell material 106. Ligands 108 may be included to help separate (e.g., disperse) the quantum dots from one another. If the quantum dots are allowed to aggregate as they are being formed, the quantum efficiency drops and quenching of the optical emission occurs. Ligands 108 may also be used to impart certain properties to quantum dot 102, such as hydrophobicity, or to provide reaction sites for other compounds to bind. A wide variety of ligands 108 exist that may be used with quantum dot 102. In an embodiment, ligands 108 from the aliphatic amine or aliphatic acid families are used. Further details on the fabrication of the quantum dots may be found in U.S. Pat. No. 9,139,770, the disclose of which is incorporated herein by reference.

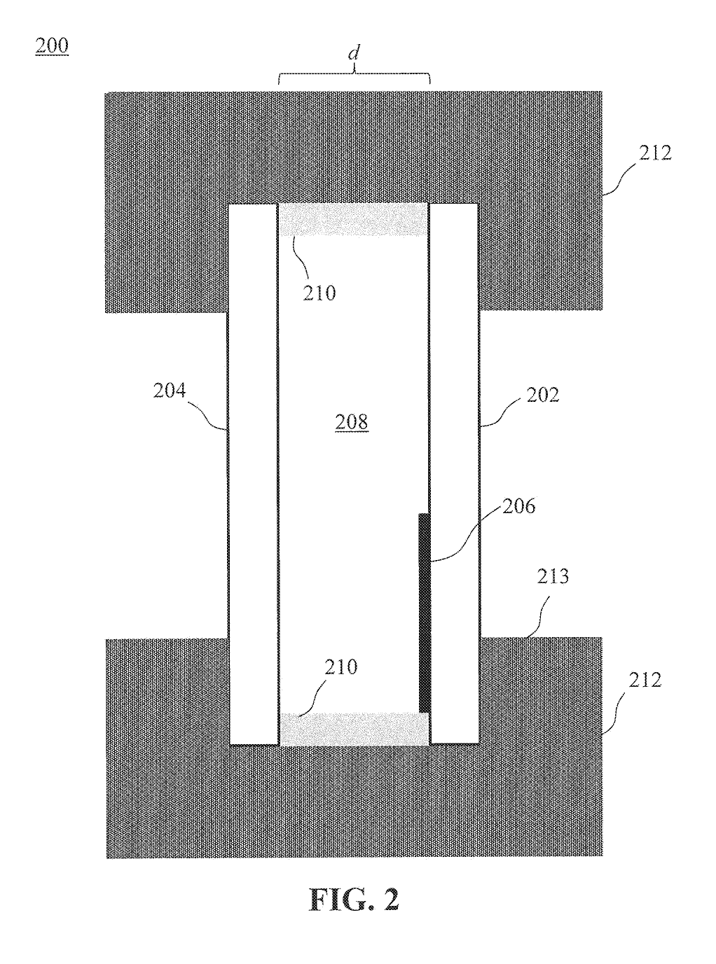

FIG. 2 illustrates a cross section of a luminescent window 200, according to an embodiment. It should be noted that the various elements of luminescent window 200 are not drawn to scale, and the various illustrated shapes or sizes of particular elements do not limit the described embodiments in any way. Luminescent window 200 may be an architectural feature of a building or in a door, or a window found on a land, air, or sea vehicle. Some examples of vehicles include automobiles, motorcycles, bicycles, trucks, airplanes, submarines, boats, etc.

Luminescent window includes a first glass pane 202 and a second glass pane 204 separated by a distance d. First glass pane 202 may be orientated substantially parallel to second glass pane 204. The distance d may vary and can be anywhere between 1 mm to 100 mm. First glass pane 202 and second glass pane 204 are substantially transparent to visible light (e.g., light having wavelengths from 400 nm to 700 nm).

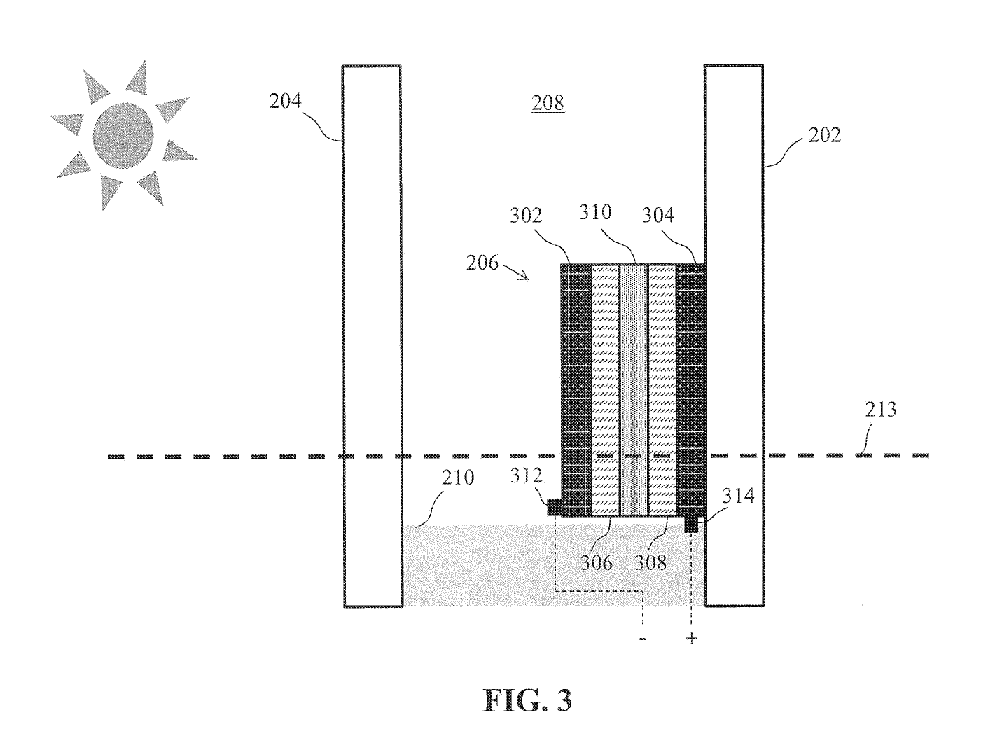

Luminescent window 200 also includes a quantum dot light emitting diode device (QLED device) 206. QLED device 206 may be a multi-layered electronic device where one of the layers includes a plurality of quantum dots. Further details on the structure of QLED device are provided later with reference to FIG. 3. QLED device 206 may be disposed on a surface of first glass pane 202 (as illustrated) or on a surface of second glass pane 204. According to an embodiment, QLED device 206 is disposed between first glass pane 202 and second glass pane 204 such that it is in a region 208 between first glass pane 202 and second glass pane 204. Region 208 may be sealed from the surrounding air and is substantially inert. For example, region 208 may be filled with an inert gas such as nitrogen or argon. The substantially inert atmosphere provided in region 208 reduces environmental degradation to QLED device 206. Additionally, the substantially inert atmosphere may allow for less expensive materials to be used in QLED device 206, since the adverse effects of moisture and reactive gases like oxygen are no longer an issue.

Luminescent window 200 may also include spacers 210 that maintain distance d between first glass pane 202 and second glass pane 204. Many window designs also include a sash 212 that covers a top and bottom portion of first glass pane 202 and second glass pane 204. Sash 212 may also be designed to structurally support first glass pane 202 and second glass pane 204 while sealing region 208 between first glass pane 202 and second glass pane 204. According to an embodiment, a portion of QLED device 206 may extend below an upper surface 213 of sash 212.

FIG. 3 illustrates a more detailed depiction of QLED device 206 on first glass pane 202, according to an embodiment. Some of the elements illustrated in FIG. 3 have been previously described with reference to FIG. 2, and thus are not described again here. QLED device 206 includes a stacked configuration of different layers to provide a voltage across a polymer layer that includes a plurality of quantum dots. According to an embodiment, QLED device 206 includes a first conductive layer 302 and a second conductive layer 304. Each conductive layer may make up the outer layers of the stacked configuration of QLED device 206. Either of first conductive layer 302 or second conductive layer 304 may be attached to the surface of first glass pane 202.

Each of first conductive layer 302 and second conductive layer 304 may be substantially transparent to visible light. Example materials for either conductive layer 302 or second conductive layer 304 include indium tin oxide (ITO) or a nanowire mesh. The nanowires in the nanowire mesh may be silver nanowires, or carbon nanowires. A voltage may be applied across first conductive layer 302 and second conductive layer 304 to generate an electric field between first conductive layer 302 and second conductive layer 304.

QLED device 206 may include transport layers to facilitate the transport of electrons and holes affected by the generated electric field. A first transport layer 306 associated with first conductive layer 302 may be included, while a second transport layer 308 associated with second conductive layer 304 may be included. First transport layer 306 may act as an electron transport layer (ETL) when first conductive layer 302 acts as an anode (i.e., negatively charged) for QLED device 206. First transport layer 306 may include zinc magnesium oxide nanoparticles (ZnₓMg₁₋ₓO). Second transport layer 308 may act as a hole transport layer (HTL) when second conductive layer 304 acts as a cathode (i.e., positively charged) for QLED device 206. Second transport layer 308 may include copper oxide (Cu2O) and copper gallium oxide nanoparticles (CuₓGa₁₋ₓO). the roles of first transport layer 306 and second transport layer 308 are reversed when the polarity of first conductive layer 302 and second conductive layer 304 are reversed. Each of first transport layer 306 and second transport layer 308 may be substantially transparent to visible light.

QLED device includes a QD layer 310, which includes the plurality of quantum dots that luminesce. The quantum dots included in QD layer 310 may include a mixture of various sizes to produce different colors, as would be understood to one skilled in the art. Zinc selenide (ZnSe) quantum dots may be used to achieve blue light (e.g., 420-460 nm), while indium phosphide (InP) quantum dots may be used to achieve green and red light. Having quantum dots that produce all three primary colors (red, green, blue) will ultimately produce white light.

The quantum dots within QD layer 310 may be suspended in material that is substantially transparent to visible light. QD layer 310 may include a polymer that encapsulates and protects the quantum dots suspended within it. Example materials for use in QD layer 310 include acrylates, epoxies, acrylated epoxies, ethylene-vinyl acetate, thiol-enes, polyurethane, polyethers, polyols, and polyesters. In one example, quantum dots are mixed within an amino silicone liquid and are emulsified into an epoxy resin that is coated to form QD layer 310. Further details regarding the fabrication and operation of quantum dot films may be found in U.S. Pat. No. 9,199,842, the disclosure of which is incorporated herein by reference.

A first contact 312 may be provided to make electrical contact with first conductive layer 302 while a second contact 314 may be provided to make electrical contact with second conductive layer 304. According to an embodiment, these contacts are made to the conductive layers below the top surface 213 of sash 212 (not illustrated). In this way, each contact 312 and 314 may be placed out of sight, lending to a more aesthetically pleasing design. Furthermore, each contact 312 and 314 does not need to be transparent if they are placed below top surface 213 of sash 212. First contact 312 and second contact 314 inay be any conductive material that makes a good ohmic contact to first conductive layer 302 and second conductive layer 304, respectively. Example materials for contacts 312 and 314 include tin-based solder, aluminum, copper, etc. According to an embodiment, contacts 312 and 314 are oppositely charged to form an electric field between first conductive layer 302 and second conductive layer 304. The injection of electrons/holes into QD layer 310 causes the quantum dots present in QD layer to luminesce. The direction of the majority of the light generated by the quantum dots depends on the polarity of the voltage applied to first conductive layer 302 and second conductive layer 304. The majority of the generated light is directed towards the cathode terminal (to the right in the FIG. 3 illustration).

According to an embodiment, QLED device 206 is attached to an interior glass pane, as opposed to a glass pane that directly receives radiation from sunlight (indicated in FIG. 3 by the sun graphic). If QLED device 206 were attached to a glass pane that directly receives sunlight, the heat from the sun's radiation may adversely affect the performance and lifetime of QLED device 206.

A power source may be included to supply the voltage to first conductive layer 302 and second conductive layer 304. Examples of power sources include batteries of any size and voltage rating and capacitors that may supply a charge over a period of time as they discharge. In another embodiment, power may be received from a standard wall outlet (United States standard of 120 V AC), which has its voltage reduced and converted to a DC voltage via a standard AC to DC converter. A user may actuate a switch to apply voltage to QLED device 206, or a variable switch to apply various voltages to QLED device 206, thus varying the brightness of the generated light.

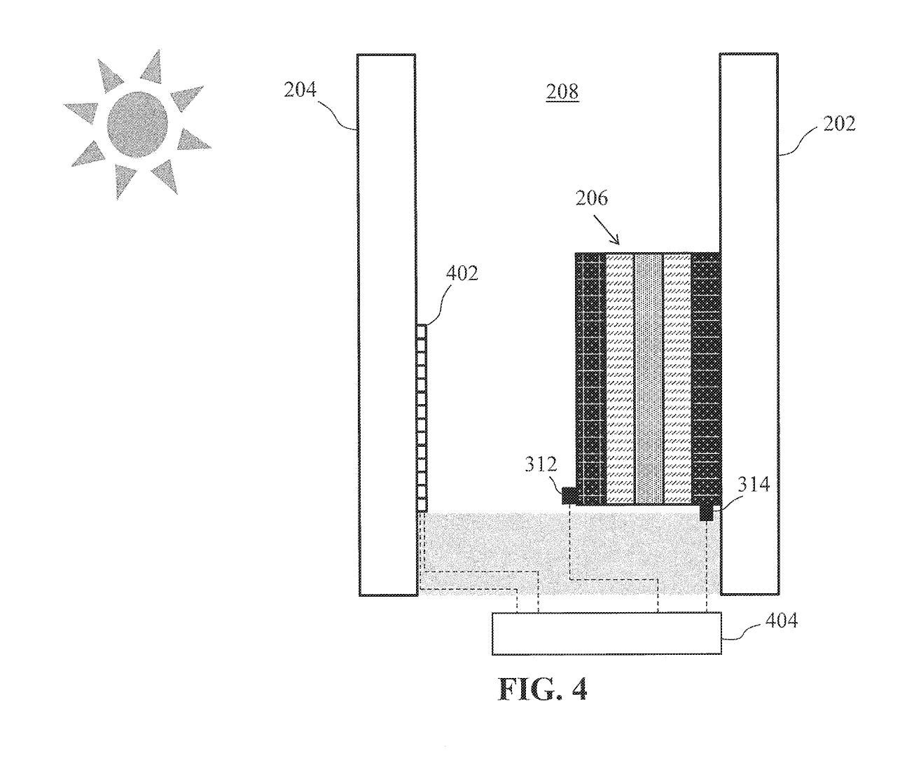

FIG. 4 illustrates another view of QLED device 206 that also includes an array of photovoltaic cells 402, according to an embodiment. Photovoltaic cells 402 may be attached to second glass pane 204, such that they are positioned to receive sunlight. In other examples, photovoltaic cells 402 may also be attached to first glass pane 202, or remote from either glass pane 202 or 204. Photovoltaic cells 402 may be arranged as one or more semiconductor devices that are designed to transduce received radiation from a light source into electrical energy. The specific design of photovoltaic cells 402 is not the focus of the current application, and would be generally understood by one skilled in the art.

The electrical leads from photovoltaic cells 402 and from first contact 312 and second contact 314 are received by a charging circuit 404, according to an embodiment. Charging circuit 404 includes various electrical components arranged to receive the voltage being generated from photovoltaic cells 402, store the generated voltage in a storage device, and provide the stored voltage to contacts 312 and 314. The exact details of charging circuit 404 are not the focus of the current application, and would be generally understood by one skilled in the art. Generally, charging circuit 404 may include one or more capacitors that store the charge generated from photovoltaic cells 402. Charging circuit 404 may then be designed to discharge the one or more capacitors to provide the voltage to contacts 312 and 314.

In one embodiment, charging circuit 404 includes a light sensor. When the intensity of the light received by light sensor is above a given threshold, charging circuit 404 may operate in first mode where charge generated from photovoltaic cells 402 is stored in one or more capacitors. When the light received by light sensor drops below the given threshold, charging circuit 404 may operate in a second mode where the charge stored in the one or more capacitors is discharged to generate a voltage between contacts 312 and 314. In this way, photovoltaic cells 402 and charging circuit 404 may work together to store charge during the daytime, and discharge the stored charge at night to illuminate QLED device 206.

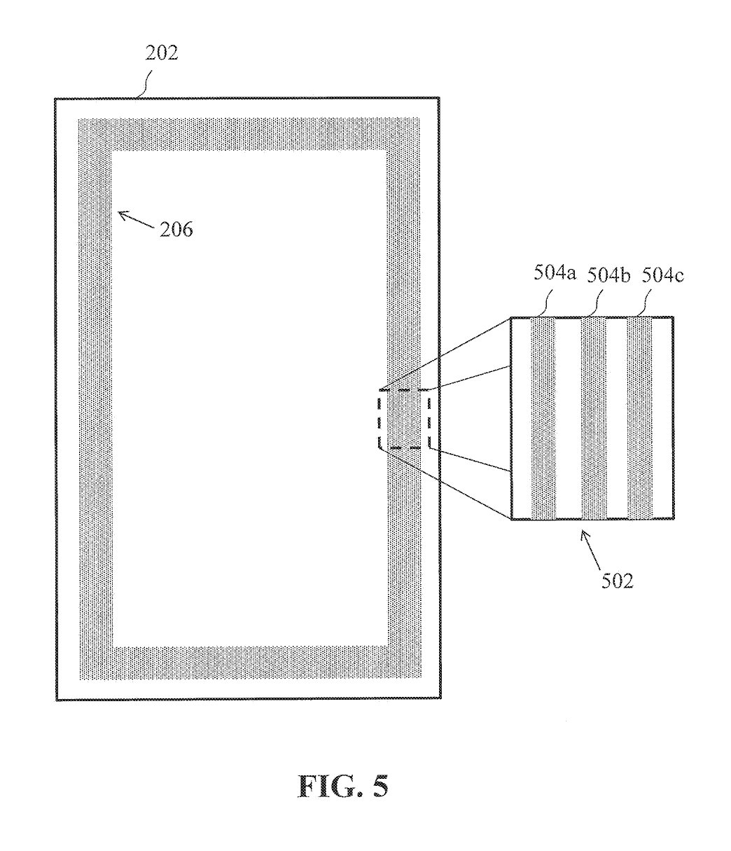

FIG. 5 illustrates a top-down view of the major surface of first glass pane 202 having QLED device 206 arranged on its major surface, according to an embodiment. In this example, QLED device 206 forms a connected loop around the perimeter of first glass pane 202. It should be understood that QLED device 206 may also fill the entire surface of first glass pane 202, or be arranged in any other shape on the surface of first glass pane 202.

In one example, a blown-up portion 502 of QLED device 206 illustrates how QLED device 206 may be segmented into multiple QLED strips 504a-504c. Although only three strips are illustrated here, QLED device 206 may be segmented into any number of concentric strips.

Each QLED strip may be arranged having a pitch between 5 micrometers and 20 15 micrometers. In one example, the pitch between QLED strips is 10 micrometers. Each QLED strip 504a-504c may include quantum dots that emit a different peak wavelength (i.e., different color) than any of the quantum dots included in the other QLED strips. For example, QLED strip 504a only includes quantum dots that emit blue light, QLED strip 504b only includes quantum dots that emit green light, and QLED strip 504c only includes quantum dots that emit red light. Other colors may be chosen as well, depending on the size of the quantum dots included in each QLED strip. The arrangement of red, green, blue QLED strips 504a-504c may be repeated any number of times to form multiple concentric QLED strips around the perimeter of first glass pane 202 having a repeating red, green, blue pattern. In other examples, QLED strips 504a-504c are arranged in any pattern on the surface of first glass pane 202.

Each QLED strip 504a-504c may be actuated together, or may be separately actuated to provide any color in the visible spectrum. Distinct contacts may be made to each QLED strip 504a-504c when they are to be actuated separately.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. An illumination device, comprising:
a first conductive layer;
a second conductive layer; and
a polymer layer disposed between the first conductive layer and the second conductive layer, the polymer layer comprising a plurality of quantum dots,
wherein the first conductive layer, the polymer layer, and the second conductive layer are configured to form a layer stack disposed on a surface of a window pane.

2. The illumination device of claim 1, wherein the layer stack is disposed within a substantially inert atmosphere.

3. The illumination device of claim 2, wherein the substantially inert atmosphere exists between the window pane and a second window pane oriented substantially parallel with the window pane, and separated from the window pane by a given distance.

4. The illumination device of claim 3, further comprising an anode contact configured to electrically contact the first conductive layer, and a cathode contact configured to electrically contact the second conductive layer, wherein an outer edge of the window pane and the second window pane is covered by a sash, and wherein the anode contact and the cathode contact are disposed behind the sash.

5. The illumination device of claim 1, further comprising one or more photovoltaic cells configured to convert electromagnetic radiation into electrical energy; and a storage device configured to store the electrical energy.

6. The illumination device of claim 5, wherein the storage device is configured to provide the electrical energy as a voltage between the first conductive layer and the second conductive layer of the illumination device.

7. The illumination device of claim 1, wherein the plurality of quantum dots comprise zinc selenide (ZnSe) quantum dots and indium phosphide (InP) quantum dots.

8. The illumination device of claim 1, wherein the first conductive layer and the second conductive layer each comprise indium tin oxide (ITO) or a nanowire mesh.

9. The illumination device of claim 1, wherein the layer stack is segmented into a plurality of layer stacks, each of the plurality of layer stacks having a polymer layer with quantum dots that emit a different peak wavelength of light than any of the quantum dots included in other ones of the plurality of layer stacks.

10. The illumination device of claim 9, wherein the plurality of layer stacks are arranged as concentric strips on the surface of the window pane.

11. The illumination device of claim 1, further comprising a first transport layer configured to facilitate the transport of electrons from the first conductive layer to the polymer layer, and a second transport layer configured to facilitate the transport of holes from the second conductive layer to the polymer layer.

12. A luminescent window, comprising:
a first glass pane;
a second glass pane oriented substantially parallel with the first glass pane, and separated from the first glass pane by a given distance;
a QLED device comprising:
a first conductive layer,
a second conductive layer, and
a polymer layer disposed between the first conductive layer and the second conductive layer, the polymer layer comprising a plurality of quantum dots,
wherein the QLED device is disposed on a surface of the first glass pane or a surface of the second glass pane, such that the QLED device is between the first glass pane and the second glass pane.

13. The luminescent window of claim 12, wherein the space between the first glass pane and the second glass pane comprises a substantially inert atmosphere.

14. The luminescent window of claim 13, further comprising an anode contact configured to electrically contact the first conductive layer, and a cathode contact configured to electrically contact the second conductive layer, wherein an outer edge of the first glass pane and the second glass pane is covered by a sash, and wherein the anode contact and the cathode contact are disposed behind the sash.

15. The luminescent window of claim 12, further comprising one or more photovoltaic cells configured to convert electromagnetic radiation into electrical energy; and a storage device configured to store the electrical energy.

16. The luminescent window of claim 15, wherein the storage device is configured to provide the electrical energy as a voltage to the first conductive layer and the second conductive layer of the illumination device.

17. The luminescent window of claim 12, wherein the plurality of quantum dots comprise zinc selenide (ZnSe) quantum dots and indium phosphide (InP) quantum dots.

18. The luminescent window of claim 12, wherein the first conductive layer and the second conductive layer each comprise indium tin oxide (ITO) or a nanowire mesh.

19. The luminescent window of claim 12, further comprising a plurality of QLED devices each having a polymer layer with quantum dots that emit a different peak wavelength of light than any of the quantum dots included in other ones of the plurality of QLED devices.

20. The luminescent window of claim 19, wherein the plurality of QLED devices are arranged as concentric strips on the surface of the first glass pane or the surface of the second glass pane.
